(19) United States
(12) Patent Application Publication
(10) Pub. No.: US 2002/0087947 A1
(43) Pub. Date: Jul. 4, 2002

(54) Method for adaptation of binary components through adaptation components

(76) Inventors: Oh-Cheon Kwon, Taejon (KR); Jeoung-Ah Kim, Kangrung-shi (KR); Seok-Jin Yoon, Taejon (KR); Gyu-Sang Shin, Taejon (KR)

Correspondence Address: JACOBSON, PRICE, HOLMAN & STERN, PROFESSIONAL LIMETED LIABILITY COMPANY, 400 Seventh Street, N.W., Washington, DC, 20004, US

(21) Appl. No.: 09/793,081

(22) Filed: Feb. 27, 2001

(30) Foreign Application Priority Data
Dec. 30, 2000 (KR) 2000-86646

(51) Int. Cl. G06F 9/44

(52) U.S. Cl. 717/120

(57) ABSTRACT

In the adaptation method for binary components through adaptation components and a computer-readable record media storing program instructions for performing the inventive method, the type of adaptation is first identified. Then, an adaptation pattern component required for the adaptation type is developed, and the developed adaptation component takes charge of the adaptation of the respective type, to thereby reduce the frequency of wrapping performed whenever the items of a requirement are changed and to prevent the size of the component from being continuously enlarged. The inventive method includes a first step of searching for a component repository, clarifying that the search for a corresponding component is successfully performed, and extracting component information using an information extractor; a second step of comparing the functionality of the searched component with the requirement of a component reuser, and deciding whether they match up; and a third step of reusing the component on an “as-is” basis if the functionality of the component and the requirement of the component reuser match up in the second step, and deciding the type of a mismatch and generating an adapted component if they do not match up.

### FIELD OF THE INVENTION

The present invention relates to a method for adaptation of binary components through adaptation components; and, more particularly, a record medium capable of being read through a computer that keeps a program to implement the inventive technique. The method improves a shortcoming that a component becomes larger continuously by adaptation for the same reason.

### PRIOR ART OF THE INVENTION

Component-Oriented Programming (COP) is considered as a promising technology in a software engineering field, with recognition as a better method of software development through reuse. The goal of COP is to develop re-usable components necessary for Component-Based Software Development (CBSD).

An application development in CBSD is carried out through the steps of selecting, adapting and composing the components like the conventional reuse method, rather than developing software from scratch.

It can be considered that COP has many similar points to Object-Oriented Programming (OOP) . That is, both code and data are defined in the component, and an interface capable of being invoked by other components is also provided by the component. The component is utilized by an application plug-in style and can be reused on an “as-is” basis.

However, it has been reported through much research that “as-is” reuse (i.e., black box reuse) is difficult to be applied in the industry, and does not work in almost all the application developments. In other words, in order to get the component matched with requirements of the application, it is generally needed to adapt the component through an adaptation method. A necessity of the component adaptation for supporting component-based reuse is defined as follows. Component reuse has a difference from the conventional library-based reuse and the conventional framework-based reuse, therefore, a new adaptation technique is required herein.

Firstly, in terms of a characteristic of CBSD, as defined above, CBSD requires an environment for building a system through the composition of standardized interfaces of components, instead of software reuse through a simple extension by generation or inheritance of code using the conventional library.

Secondly, in terms of a characteristic of the component, the component to be reused for COP is executable code in a black box type in which source code is not provided. In other words, it is impossible to perform the component adaptation through a correction or inheritance of code which is white box reuse, since the component is not provided in the source code type. Therefore, component reusers require a reuse method different from the conventional source code-based reuse, and also require the techniques for supporting the reuse method.

Thirdly, in terms of a necessity for domain architecture-based reuse, although the component of the black box type is a general-purpose component that can be reused for all applications, the component has the context of reuse which is defined by an interface of the component. That is, the assembly of components into larger components or applications depends upon the characteristics of the “Provided and Required interfaces” of the components. The component for supporting a specific domain may have the context and meaning differently defined according to the domain. Therefore, architecture-based reuse should be performed in order to increase the effectiveness of component reuse.

It is essentially needed to perform a procedure of composing or integrating the components in component reuse. An assembly of the components may be made easily without mismatches between component interfaces, but such an assembly is carried out only when the contents of the interfaces such as an interface and attribute name, an operation name, and a parameter name and type match up completely. Therefore, if the interfaces are different from each other, component reusers require a more natural method for connecting the components. That is, it is necessary for the component reusers to carry out an adaptation of the component. The techniques for the adaptation can be classified as follows.

Firstly, there is an adapter technique. The adapter technique resolves the differences between the interfaces by defining an adapter class between two classes whose interfaces do not match up. The adapter class is defined using an adapter pattern and resolves the mismatches between the interfaces of two components.

Secondly, there is also a wrapper technique. The wrapper technique is performed by defining the wrapper class for an adapted component.

Thirdly, a binary adaptation technique is to directly rewrite the original component of a binary type according to new requirements.

In the present invention, the wrapper technique among the above techniques is chosen and described in more details as follows.

FIG. 1 shows the process of component adaptation using the wrapping technique. When a new requirement 101 for the original component 100 occurs, the original component is wrapped to make a newly adapted component 102. In addition, when another new requirement 103 occurs, the component 102 is wrapped so as to meet the new requirement, and then an adapted component 104 is generated.

As described above, the conventional wrapping method constructs newly the component by adding a new function to a prefabricated component. The wrapping method has a problem that a component is continuously extended, since the original component is wrapped by the new function whenever component adaptation is required.

### SUMMARY OF THE INVENTION

It is an object of the present invention to provide an adaptation method for binary components through adaptation components. After the cause of an adaptation is identified, an adaptation component required for the adaptation type is selected, and the developed adaptation component takes charge of the adaptation for the specific type, to thereby reduce the frequency of wrapping performed whenever the items of a requirement are changed and to prevent the component from being continuously enlarged by generating the wrapper classes for the same reason, and to also make a computer-readable record media storing program instructions for performing the inventive method.

To achieve these advantages, the adaptation method for binary components through adaptation components includes the following steps. The first step is to search for a component from the repository, and to extract component information using an information extractor if the search for a corresponding component was successfully performed. The second step is to compare the functionality of the retrieved component with the requirement of a component to be developed, and to decide whether they match up. The third step is to reuse the component on an “as-is” basis if they match up, and to identify the cause of adaptation if they do not match up, and then to generate an adapted component.

The present invention requires an additional repository for storing the meta-data describing the structure and behavioral characteristics of the component. When adapted components are executed, adaptation pattern components get the adaptation information from the repository.

The present invention also requires computer-readable record media storing program instructions for performing the method, in a Component-Based Software Development (CBSD) system equipped with a mass-storage processor, wherein the program includes the functions for supporting the three steps described above.

### BRIEF DESCRIPTION OF THE DRAWINGS

The contents and features of the present invention will become apparent from the following description of preferred embodiments taken in conjunction with the accompanying drawings, in which:

FIG. 1 represents an explanatory diagram of one embodiment for a component adaptation procedure using a conventional wrapping technique;

FIG. 2 shows an explanatory diagram illustrating the adaptation method of a component through an adaptation component in accordance with the present invention;

FIG. 3 illustrates a detailed explanatory diagram for an adaptation method of a component through an adaptation component in accordance with the present invention;

FIG. 4 is a flowchart illustrating the procedure of generating an adapted component through an adaptation specification and adaptation component according to the present invention;

FIG. 5 depicts a flowchart of one embodiment of the procedure for generating meta model information according to the present invention;

FIG. 6 is an explanatory diagram illustrating an adapted component based on a meta model according to the present invention;

FIG. 7 is a detailed explanatory diagram illustrating the structure of an adapted component, including a adaptation component for modifying attributes according to the invention; and

FIG. 8 shows a flowchart illustrating a procedure in which an adapted component is actually performed together with meta models, according to the present invention.

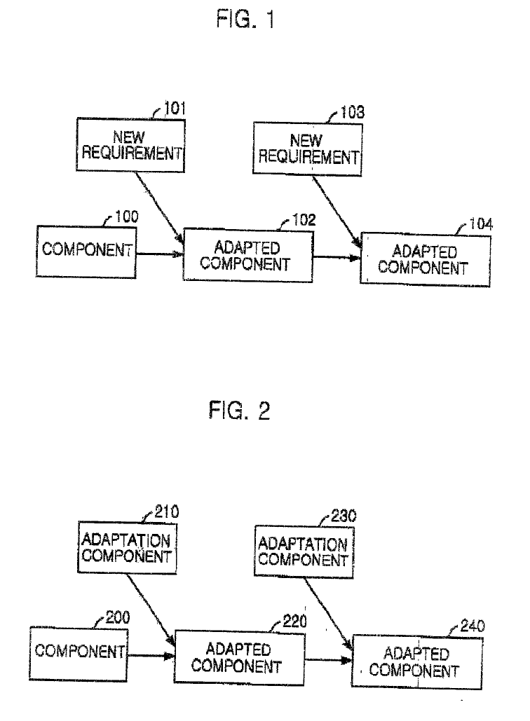

### DETAILED DESCRIPTION OF THE PREFERRED EMBODIMENTS

Hereinafter, preferred embodiments of the present invention will be described in detail with reference to the accompanying drawings.

FIG. 2 is an explanatory diagram illustrating the adaptation method of a component through an adaptation component according to the present invention.

In the invention, the adaptation of the component is required when management items to be processed by the component are newly added or deleted. Examples of these cases are a change of an attribute or an interface name, a change of an interface addition/deletion, and a change of a method in which a new algorithm for an already defined interface is defined.

In the invention, the causes of the adaptation are defined as types of the adaptation, and herewith the adaptation of the component is performed through an adaptation component for supporting the type of the adaptation.

As shown in FIG. 2, for adapting the component through the adaptation component, an adaptation component 210 matched with the cause of a new requirement is wrapped with an original component 200, to thus create an adapted component 220. When another new requirement occurs, an adaptation component 230 matched with the cause of the new requirement is wrapped, to thus generate an adapted component 240.

Herewith, if the adaptation of the same type is needed, adaptation is performed by using the already wrapped adaptation components 210 and 230, therefore, more wrapping by the adaptation of the same cause is not performed.

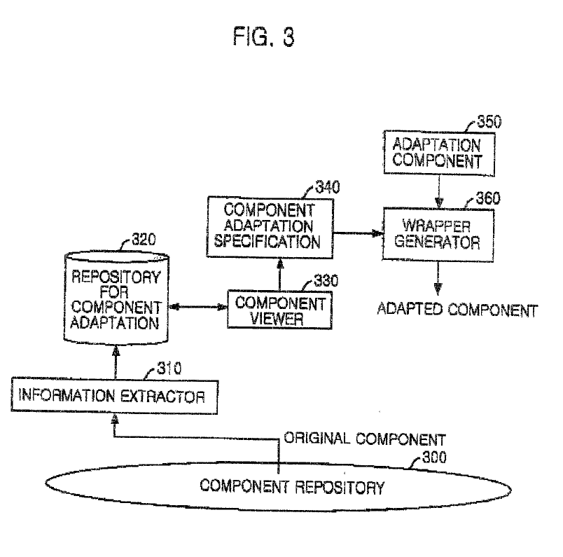

FIG. 3 is a detailed explanatory diagram illustrating the adaptation method of the component through the adaptation component according to the present invention.

FIG. 3 shows the process of component adaptation through the adaptation component. Firstly, an original component to be adapted is taken from a component repository 300, and static information, namely, a name of a component, a name of an interface, a type of a parameter, etc., is extracted by an information extractor 310 and is stored in a repository 320 for component adaptation.

Then, the information stored in the repository 320 for component adaptation is identified and understood through a component viewer 330. Through an analysis of a new requirement, the cause (e.g., type) of the adaptation or correction is grasped, and the contents of the adaptation are described in a component adaptation specification 340. An adaptation component 350 contained in a system repository is selected according to the cause of the adaptation described in the component adaptation specification 340, to then generate an adapted component through a wrapper generator 360.

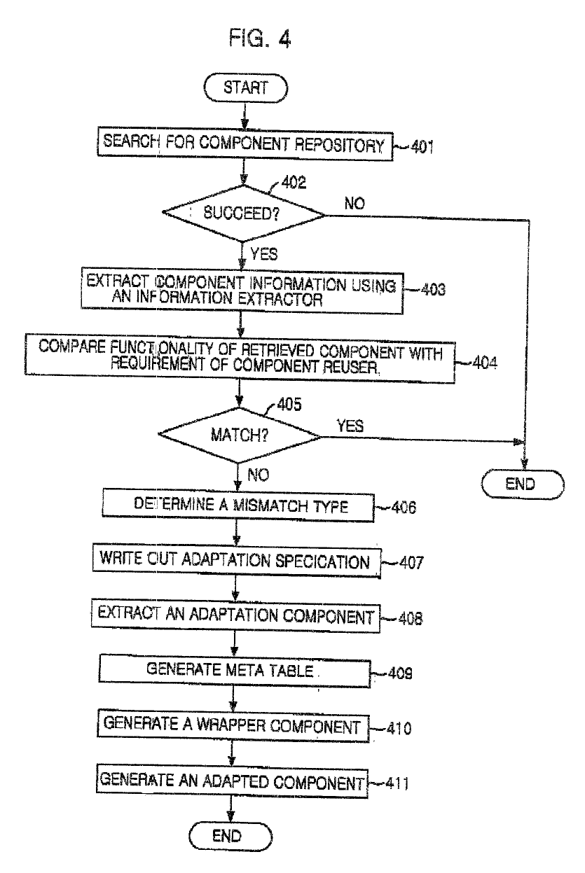

FIG. 4 is a flowchart of one embodiment for the procedure of generating an adapted component through an adaptation specification and adaptation component in the present invention.

As shown in FIG. 4, in step 401, a component to be reused is firstly retrieved from a component repository. Then, the step 402 decides whether or not a corresponding component is successfully searched.

If the search for the corresponding component is not successfully performed in the above step 402, a new component needs to be developed through component engineering. If the search for the corresponding component succeeds, the corresponding component is inputted to the information extractor in order to extract the static information of the component in step 403.

The functionality of an original component is compared with the requirements of a component to be developed in step 404, and it is decided in step 405 whether they match up.

If the functionality of the original component is matched up with the requirements of the component, the component is reused on an “as-is” basis, and if they do not match up, the type of a mismatch should be decided in step 406.

After the cause and content of a mismatch are decided and understood, the specification of an adaptation is written through a general editor in step 407, and an adaptation component for processing the component adaptation specification is extracted in step 408. Then, the static information of the original component is merged with information needed for adaptation, to generate a meta-model in step 409. Finally, a wrapper component is generated in step 410, and an adapted component for the changed requirement is generated in step 411.

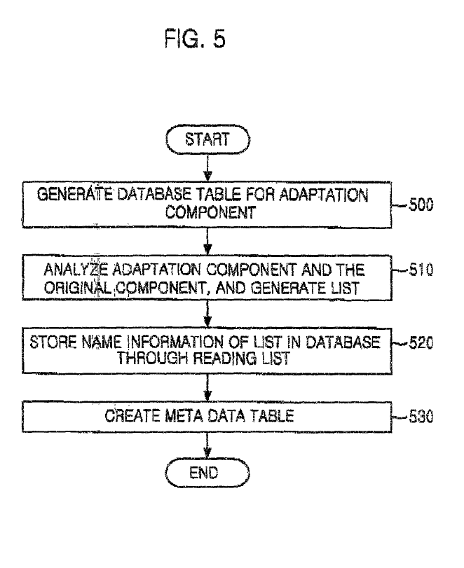

FIG. 5 is a flowchart of one embodiment of the procedure for generating meta model information in the present invention.

In order to adapt the original component in the above adaptation procedure, the meta information of the original component used by the adaptation component is managed separately from meta information of the adaptation component.

As shown in FIG. 5, in a procedure of generating the meta information, a table of a database for an adaptation component is generated in step 500, and information about the original component and adaptation component is analyzed, to generate a meta data list in step 510. The list is composed of a pair of a name and a value.

Next, the information of the name and value defined on the list is read and then stored in the database in step 520, and after all the lists are read, a table of the meta data is generated by using a database schema in step 530.

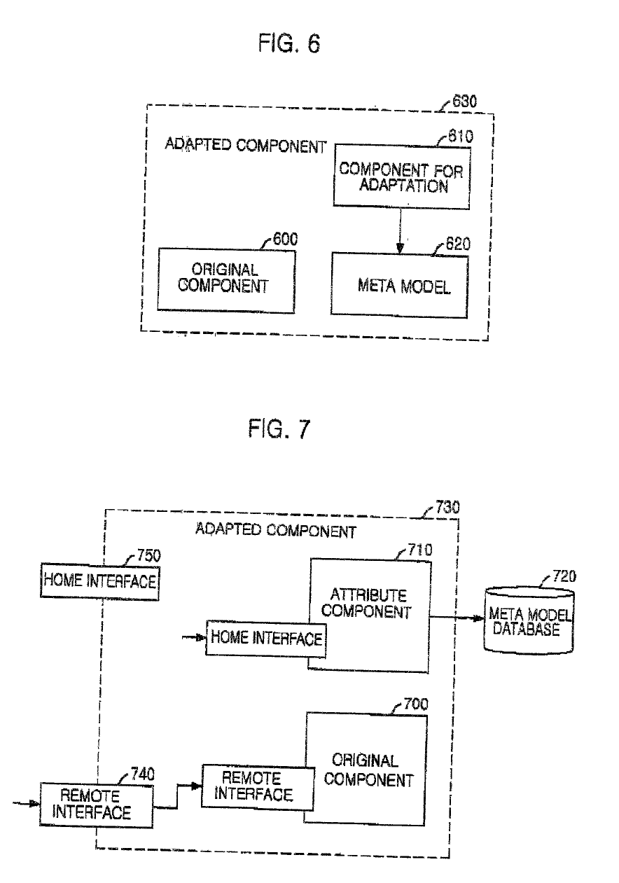

FIG. 6 is an explanatory diagram illustrating an adapted component based on a meta model in the present invention.

As shown in FIG. 6, an adaptation component 610 is defined in order to process the adaptation for the original component 600, and the meta information for an adaptation component is stored in a meta model database 620 separately from the original component, and is then reused when an execution of the component or a new adaptation is needed later.

The original component 600 and the adaptation component 610 are wrapped together, to generate a newly adapted component 630.

FIG. 7 is a detailed explanatory diagram illustrating the structure of an adapted component for one embodiment of the invention, and indicates an example in which the concept mentioned above is applied to EJB component architecture.

It is very common to add and delete an attribute for the adaptation which is processed by an attribute component 710, that is a kind of an adaptation pattern component.

The prerequisites of the technique for adding the attribute such as a new name are as follows.

Firstly, a previously defined business process is not changed by the addition of the attribute.

Secondly, an usage of the component becomes extended through an addition of Get/Set interfaces after the addition of the attribute.

Thirdly, a change of the attribute type is not allowed. That is, the attribute type already defined cannot be changed, as the adaptation of the attribute cannot be allowed in an inheritance of an object-oriented technique.

Fourthly, a change of the attribute name is allowed.

Further, a technique for adapting the attribute is described as follows.

Firstly, an interface for processing the already defined attribute is provided through an original component 700.

Secondly, an addition of a new attribute is defined by an attribute pattern component, after an addition of the attribute component 710.

Thirdly, the attribute pattern component 710 defines the newly defined attribute as a meta model in a database 720. Adaptation information is stored and managed by using the meta model stored in the database 720. If a permanent repository is required, a corresponding database can be built and managed.

Fourthly, an adapted component 730 wraps the original component 700 and the attribute component 710 together, to thus provide a remote interface 740 which defines interfaces of two components, and a home interface 750 necessary for generating a component instance.

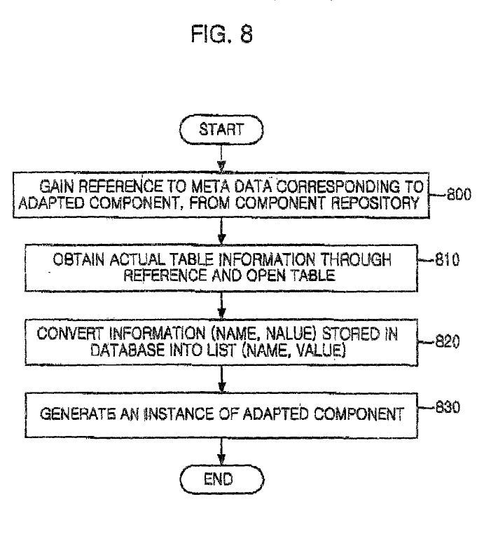

In a procedure in which the adapted component 730 defined above is actually executed, the step of using the meta data is described in FIG. 8, as follows.

FIG. 8 is a flowchart of one embodiment illustrating a procedure in which the adapted component is actually performed together with meta models, according to the present invention.

In the procedure of using the meta data, a reference to the meta data corresponding to an adapted component is obtained from a component repository in step 800, when the adapted component is executed by a procedure opposite to the procedure defined in FIG. 5. Then, the information for an attribute, a behavior and an interface defined by the original component, and the information for an attribute, an behavior and an interface newly defined by the adaptation component, are obtained in steps 810 and 820. That is, the name and value information stored in the database are converted into the name and value list.

After changing the above information to information to be mapped to the adapted component whenever a corresponding interface is called, an instance of the adapted component is generated. Therefore, the information necessary for an operation of the adapted component is stored in step 830.

Thereby, an access between the original component and the newly defined component becomes possible without hard coding for newly defined information.

The inventive method as afore-described is embodied by a program and this program can be stored in the computer-readable record media, such as a CDROM, a RAM, a ROM, a floppy disk, a hard disk, and a magnetic-optical disk, etc.

As afore-mentioned, in accordance with the present invention, a cause of the component adaptation is analyzed, and an adaptation component for resolving the adaptation is provided. Since wrapping of an adaptation pattern component with an original component is performed only one time according to the cause of the component adaptation, the size of a component is not continuously extended.

Like this, according to a repetitive adaptation procedure in the invention, a necessity for the successive wrapping of the component is eliminated, to thereby improve an efficiency of the component adaptation procedure.

In addition, the invention can be usefully applied to a server-side component whose deployment and reuse are greatly increased. It can be also used as an efficient adaptation technique, when a binary component which is currently deployed without providing a program source, is adapted according to new requirements of a component reuser. Accordingly, it can promote commercialization of a Component-Based Development (CBD) supporting tool.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. An adaptation method for binary components through adaptation pattern components, comprising the steps of:
a first step of searching for a component repository, clarifying that the search for a corresponding component is successfully performed, and extracting component information using an information extractor;
a second step of comparing the functionality of the searched component with the requirement of a component reuser, and deciding whether they match up; and
a third step of reusing the component on an “as-is” basis if the functionality of the component and the requirement of the component reuser match up in said second step, and deciding the type of a mismatch and generating an adapted component if they do not match up.

2. The method of claim 1, wherein said third step of generating the adapted component includes the steps of:
a fourth step of writing an adaptation specification and extracting an adaptation component; and
a fifth step of generating a meta model and generating a wrapper component.

3. The method of claim 2, wherein said fifth step of generating the meta model includes the steps of:
a sixth step of generating a table of a database for the adaptation component;
a seventh step of analyzing the information of the original component and adaptation component, and producing a list; and
an eighth step of storing the information defined in the list through reading the list, and generating the table of meta data from the list by using a database schema.

4. The method of claim 3, wherein said adaptation pattern component is classified into the adaptation of an attribute, the adaptation of an interface, the adaptation of a method and the adaptation of a name according to the cause of adaptation. These adaptation pattern components are reused for carrying out the adaptation of the specific type.

5. In a Component-Based Software Development (CBSD) system equipped with a mass-storage processor, computer-readable record media storing program instructions for performing an adaptation method, comprising the functions of:
searching for a component repository, clarifying that the search for a corresponding component is successfully performed, and extracting component information using an information extractor;
comparing the functionality of the searched component with the requirement of a component reuser, and deciding whether they match up; and
reusing the component on an “as-is” basis if the functionality of the component and the requirement of the component reuser match up in said second function, and deciding the type of a mismatch and generating an adapted component if they do not match up.
